(19) United States
(12) Patent Application Publication
(10) Pub. No.: US 2006/0213900 A1
(43) Pub. Date: Sep. 28, 2006

(54) Electrostatic chuck and method of manufacturing electrostatic chuck

(75) Inventors: Hiroto Matsuda, Ogaki-shi (JP); Kazuhiro Nobori, Handa-shi (JP); Yasuyoshi Imai, Santa Clara, CA (US); Tetsuya Kawajiri, Handa-shi (JP)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 11/386,222

(22) Filed: Mar. 22, 2006

(30) Foreign Application Priority Data
Mar. 24, 2005 (JP) 2005-087081

(51) Int. Cl. H05B 3/68

(52) U.S. Cl. 219/444.1

(57) ABSTRACT

An electrostatic chuck includes, a base plate made of ceramic, an electrode for generating an electrostatic clamping force, and a dielectric material layer formed on the electrode and made of ceramic having a volume resistivity of not less than 1×10¹⁵ Ω·cm at 100° C. and the same main constituent as the base plate. The base plate has a higher thermal conductivity than the dielectric material layer.

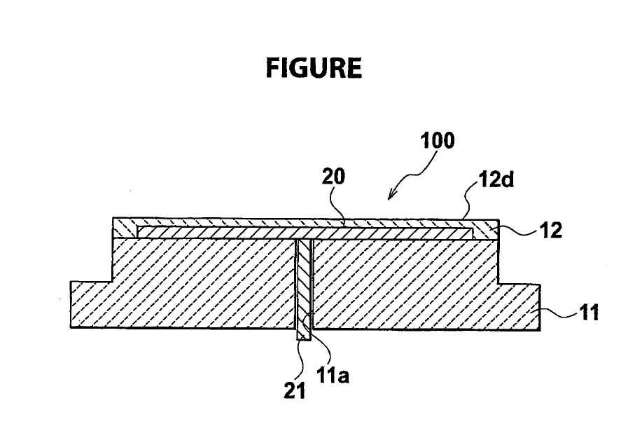

### CROSS REFERENCE TO RELATED APPLICATIONS

This application is based upon and claims the benefit of priority from prior Japanese Patent Application P2005-087081 filed on Mar. 24, 2005; the entire contents of which are incorporated by reference herein.

### BACKGROUND OF THE INVENTION

1. Field of the Invention

The present invention relates to an electrostatic chuck and a method of manufacturing the same.

2. Description of the Related Art

Heretofore, in semiconductor manufacturing processes and liquid crystal manufacturing processes, an electrostatic chuck is used which adsorbs and holds a semiconductor substrate or a glass substrate. Electrostatic chucks adsorb a substrate using Coulomb force or Johnson-Rahbek force. The Coulomb force is an electrostatic clamping force generated between a substrate placed on the surface of a dielectric material layer of the electrostatic chuck and an electrode of the electrostatic chuck. In the electrostatic chuck which adsorbs a substrate using Coulomb force, a high volume resistivity is needed within the operating temperature range in order to improve substrate dechucking characteristics.

Generally, alumina or the like is used which has a high volume resistivity at normal temperature and which is inexpensive (e.g., see Japanese Patent Laid-open Publication No. H 9-283607).

However, recently, electrostatic chucks used in semiconductor manufacturing equipment tend to be increasingly exposed to high-temperature environments. Electrostatic chucks have come to be exposed to high-temperature environments for the purpose of the deposition, etching, and the like of new constituent materials, for example, environments in which substrates are heated, such as CVD systems, and environments in which high heat is input to the substrate for high density plasma, such as etching systems and PVD systems. With this, high-thermal conductivities are being required for electrostatic chucks in order to improve temperature uniformity and to efficiently release the heat of substrates.

The thermal conductivity of alumina is as low as 30 W/mK or less. Thus, there has been the problem that when alumina is used as a material for a base plate, its heat dissipation from a substrate is low.

### SUMMARY OF THE INVENTION

A first aspect of the present invention is to provide an electrostatic chuck, including, a base plate made of ceramic, an electrode for generating an electrostatic clamping force, and a dielectric material layer formed on the electrode. The dielectric material layer is made of ceramic having a volume resistivity of not less than 1×10¹⁵ Ω·cm at 100° C. and the same main constituent as the base plate, wherein the base plate has a higher thermal conductivity than the dielectric material layer.

A second aspect of the present invention is to provide a method of manufacturing an electrostatic chuck, including, forming a base plate made of ceramic, forming an electrode for generating an electrostatic clamping force, forming on the electrode a dielectric material layer made of ceramic having a volume resistivity of not less than 1×10¹⁵ Ω·cm at 100° C. and the same main constituent as the foregoing ceramic, wherein the base plate has a higher thermal conductivity than the dielectric material layer.

### BRIEF DESCRIPTION OF THE DRAWINGS

FIGURE is a cross-sectional view illustrating an electrostatic chuck according to an embodiment of the present invention.

### DETAILED DESCRIPTION OF THE INVENTION

Various embodiments of the present invention will be described with reference to the accompanying drawing.

(Electrostatic Chuck)

As illustrated in FIGURE, an electrostatic chuck 100 includes a base plate 11, an electrode 20, a dielectric material layer 12, and a terminal 21.

The electrostatic chuck 100 includes the base plate 11 made of ceramic having a higher thermal conductivity than the dielectric material layer 12; the electrode 20 for generating an electrostatic clamping force; and the dielectric material layer 12 formed on the electrode 20 and made of ceramic having a volume resistivity of not less than 1×10¹⁵ Ω·cm at 100° C., 150° C., and 200° C. and containing the same main constituent as the base plate 11. This can function as an electrostatic chuck having high volume resistance and high thermal conductivity in a high-temperature environment.

The electrostatic chuck 100 has a structure in which the electrode 20 is interposed between the base plate 11 and the dielectric material layer 12. The electrostatic chuck 100 is an electrostatic chuck using Coulomb force, and the dielectric material layer 12 functions as a dielectric layer. The electrostatic chuck 100 adsorbs a substrate to the surface of the dielectric material layer 12 (hereinafter referred to as the “substrate contact surface 12d”).

The base plate 11 supports the electrode 20 and the dielectric material layer 12. The base plate 11 consists of ceramic having a higher thermal conductivity than the dielectric material layer 12. The thermal conductivity of the base plate 11 is preferably not less than 80 W/mK. In this case, since the base plate 11 has high thermal conductivity, heat dissipation from the substrate can be improved. The thermal conductivity of the base plate 11 is more preferably not less than 150 W/mK.

The base plate 11 consists of ceramic which is essentially contained in the dielectric material layer 12. This makes it possible to improve adhesion between the base plate 11 and the dielectric material layer 12.

It is preferred that the base plate 11 essentially contains aluminum nitride. This makes it possible to further increase the thermal conductivity of the base plate 11. In the case where the base plate 11 is made of a sintered aluminum nitride material, the relative density thereof is preferably not less than 98%. This makes it possible to improve the denseness and an insulating property of the base plate 11.

The base plate 11 can contain sintering aids such as magnesia, yttria, titanium oxide, samaria, alumina, ytterbium, and ceria. It should be noted, however, that the total amount of constituents except for the raw material of the main constituent, is preferably not more than 10 wt %. The base plate 11 can be formed into the shape of a plate, such as a disk-like shape and has a hole 11a for inserting the terminal 21.

The dielectric material layer 12 is formed on the base plate 11 with the electrode 20 interposed therebetween. The dielectric material layer 12 can be made of ceramic having a volume resistivity of not less than 1×10¹⁵ Ω at 100° C., 150° C., and 200° C., as well as the main constituent of the base plate 11. In this case, since the dielectric material layer 12 has high volume resistance in a high-temperature environment, it is possible to increase a Coulomb force generated between the substrate and the substrate contact surface 12d which is the surface of the dielectric material layer 12 that contacts with the substrate. This enables the dielectric material layer 12 to function as a dielectric layer of the electrostatic chuck 100 which has high volume resistance in a high-temperature environment and which uses a Coulomb force.

It is preferred that the dielectric material layer 12 essentially contains aluminum nitride. This makes it possible to increase the thermal conductivity of the dielectric material layer 12. This enables the dielectric material layer 12 to have high volume resistance and further have high thermal conductivity.

It is preferred that the dielectric material layer 12 essentially contains aluminum nitride, and also contains 0.4 to 2.5 wt % magnesium and 2.0 to 5.0 wt % yttrium, preferably, an average grain size is not more than 1.0 μm. In this case, since the volume resistivity of the dielectric material layer 12 is further increased, the Coulomb force generated between the substrate contact surface 12b and the substrate can further be increased. More preferable amount of magnesium contained in the sintered aluminum nitride material is 0.5 to 2.5 wt %. This makes it possible to further increase the volume resistivity of the dielectric material layer 12.

It is preferred that the dielectric material layer 12 has a volume resistivity of not less than 1×10¹⁵ Ω·cm under conditions where the dielectric material layer 12 is held at room temperature in a vacuum, and subjected to voltage application of 2 kV/mm for one minute. This enables the dielectric material layer 12 to have a high electrostatic clamping force in a high-voltage environment. It is more preferred that the dielectric material layer 12 has a volume resistivity of not less than 1×10¹⁶ Ω·cm under conditions where the dielectric material layer 12 is held at room temperature in a vacuum, and subjected to voltage application of 2 kV/mm for one minute.

Further, it is preferred that the dielectric material layer 12 has a volume resistivity of not less than 1×10¹⁵ Ω·cm under conditions where the dielectric material layer 12 is held at 100° C. in a vacuum and subjected to voltage application of 2 kV/mm for one minute. In the same manner, the dielectric material layer 12 has a volume resistivity of not less than 1×10¹⁵ Ω·cm under conditions where the dielectric material layer 12 is held at 150° C. in a vacuum, and subjected to voltage application of 2 kV/mm for one minute. Furthermore, it is preferred that the dielectric material layer 12 has a volume resistivity of not less than 1×10¹⁵ Ω·cm under conditions where the dielectric material layer 12 is held at 200° C. in a vacuum, and subjected to voltage application of 2 kV/mm for one minute. This enables the dielectric material layer 12 to have a high electrostatic clamping force in a high-temperature, high-voltage environment. It is more preferred that the dielectric material layer 12 has a volume resistivity of not less than 1×10¹⁶ Ω·cm under conditions where the dielectric material layer 12 is held at 200° C. in a vacuum, and subjected to voltage application of 2 kV/mm for one minute.

In the case where the dielectric material layer 12 is made of a sintered aluminum nitride material, it is preferred that the relative density thereof is not less than 98%. This makes it possible to make the dielectric material layer 12 can be dense. In the case where the dielectric material layer 12 is made of a sintered aluminum nitride material, it is preferred that the grain sizes are not more than 1.0 μm. This makes it possible to increase the volume resistivity of the dielectric material layer 12.

The dielectric material layer 12 may contain sintering aids such as magnesia, yttria, and titanium oxide. It should be noted, however, that the total amount of constituents except for the raw material of the main constituent is preferably not more than 12 wt %.

The thickness of the dielectric material layer 12 is preferably not more than 0.5 mm. This makes it possible to obtain a high electrostatic clamping force. The thickness of the dielectric material layer 12 is more preferably not more than 0.4 mm.

The center line average surface roughness (Ra) (JIS B0601) of the substrate contact surface 12d is preferably not more than 1.6 μm. This makes it possible to increase the clamping force and reduce a gas leak rate in the case where backside gas is introduced on the back surface of the substrate. It is preferred that the center line average surface roughness (Ra) is not more than 0.8 μm.

The electrode 20 generates Coulomb force between the substrate contact surface 12d and the substrate. The electrode 20 is interposed between the base plate 11 and the dielectric material layer 12. In the electrostatic chuck 100, the electrode 20 is embedded between the base plate 11 and the dielectric material layer 12. For the electrode 20, high-melting-point material can be used, such as tungsten (W), niobium (Nb), molybdenum (Mo), tantalum (Ta), hafnium (Hf), platinum (Pt), tungsten carbide (WC), or an alloy or chemical compound thereof. In the case where aluminum nitride is essentially contained in the base plate 11 and the dielectric material layer 12, molybdenum, tungsten, or, tungsten carbide as electrode material makes it possible to improve adhesion between the base plate 11 and the dielectric material layer 12, because their thermal expansion coefficients are close to that of aluminum nitride.

The electrode 20 is not limited to a unipolar shape such as illustrated in FIGURE, but may be divided into double poles or a plurality of portions. The shape of the electrode 20 is not limited, but may be in the form of disk, D-shape, interdigital fingers or any shape.

The electrode 20 may be formed of print paste printed, a mesh metal, a bulk metal, a sheet metal, a thin film formed by chemical vapor deposition (CVD) or physical vapor deposition (PVD), or the like.

The terminal 21 is connected to the electrode 20 by brazing or the like.

It is preferred that the base plate 11 and the dielectric material layer 12 contain the same main constituent and be integrated with the electrode 20 into a single-piece sintered body. This makes it possible to improve denseness of the base plate 11 and the electrode 20, and adhesion between the base plate 11, the electrode 20, and the dielectric material layer 12. In particular, hot pressing is preferred to sinter the base plate 11, the electrode 20, and the dielectric material layer 12 into a single-piece sintered body.

The electrode 20 may not be located between the base plate 11 and the dielectric material layer 12. For example, the electrode 20 may be embedded in the dielectric material layer 12.

Moreover, the electrostatic chuck 100 can also be in a configuration of being an electrostatic chuck capable of heating the substrate with an embedded resistance heating element in the base plate 11. For the resistance heating element, niobium, molybdenum, tungsten, or the like can be used. The resistance heating element may be of a linear shape, a coil shape, a band-like shape, a mesh-like shape, a film-like shape, or the like. The resistance heating element generates heat upon receipt of power supply.

(Manufacturing Method)

The above-described electrostatic chuck 100 can be manufactured by the steps of forming the base plate 11 of ceramic having a higher thermal conductivity than the dielectric material layer 12, forming the electrode 20 for generating an electrostatic clamping force, and forming on the electrode 20 the dielectric material layer 12 of ceramic having a volume resistivity of not less than 1×10¹⁵ Ω·cm at 100° C. and containing the same main constituent as the base plate 11. It should be noted that it is preferred that the base plate 11 has a thermal conductivity of not less than 80 W/mK Further, it is preferred that the dielectric material layer 12 has a volume resistivity of not less than 1×10¹⁵ Ω·cm at 150° C. and 200° C.

A description will be given by taking the case as an example where the base plate 11 is formed, and the dielectric material layer 12 is formed on the base plate 11 with the electrode 20 interposed therebetween.

First, a binder and, as needed, an organic solvent, a dispersing agent, and the like as needed, are added to and mixed with ceramic raw material powder for the base plate 11 which has a higher thermal conductivity than the dielectric material layer 12, thus preparing slurry. The ceramic raw material powder contains ceramic powder as a main constituent, and sintering aids. For example, the ceramic raw material powder essentially contains aluminum nitride powder; and sintering aids such as magnesia, yttria, titanium oxide, samaria, alumina, ytterbium, and ceria, are added thereto. It should be noted, however, that it is preferred that the total amount of constituents except for the raw material of the main constituent is not more than 10 wt %. Further, in the case where aluminum nitride is essentially contained in the raw material powder, it is preferred that the average grain size is approximately 1 μm. This makes it possible to lower sintering temperature.

The slurry obtained is granulated by spray granulation or the like, thus obtaining granules. The obtained granules are molded by a molding method such as die molding, cold isostatic pressing (CIP), or slip casting.

A molded body obtained is sintered under sintering conditions (sintering atmosphere, sintering method, sintering temperature, sintering time, and the like) according to the ceramic raw material powder, thus forming the base plate 11 of ceramic. Specifically, in the case where aluminum nitride is used as a main constituent of the raw material powder, it is preferred that the molded body is sintered at 1400 to 2000° C. in an inert gas atmosphere such as nitrogen gas or argon gas while being uniaxially pressurized. In the case where the sintering temperature is less than 1400° C., densification is difficult. In the case where the sintering temperature exceeds 2000° C., the volume resistance of the dielectric layer is lowered. More preferable temperature is 1600 to 2000° C. This makes it possible to further stabilize characteristics of the base plate 11 obtained. Further, it is preferred that the temperature is raised to maximum temperature at a heating rate of not more than 200° C./hour. It is preferred that the temperature is held at the maximum temperature for one to ten hours.

A sintering method is preferably hot pressing. This makes it possible to form a dense sintered aluminum nitride material and increase the volume resistivity of the sintered aluminum nitride material obtained. It is preferred that the pressure applied in this case is 10 to 30 MPa. This makes it possible to obtain a denser sintered body as the base plate 11.

For example, the molded body formed is sintered by heating the molded body at a maximum temperature of 1830° C. under a pressing pressure of 20 MPa for two hours.

Next, the electrode 20 is formed on the base plate 11. The electrode 20 can be formed by printing print paste in a semicircular shape, a interdigital finger shape, or a circler shape on a surface of the base plate 11 using screen printing or the like. In the case where the electrode 20 is formed by printing, it is preferred to use print paste obtained by mixing powder of high-melting-point material such as tungsten, niobium, molybdenum, or tungsten carbide; ceramic powder of the same kind as that of the base plate 11; and binder such as cellulose, acrylic, polyvinyl butyral, or the like. This makes it possible to bring the thermal expansion coefficients of the electrode 20 and the base plate 11 close to each other and improve denseness between the base plate 11 and the electrode 20.

Alternatively, the electrode 20 can also be formed by placing the electrode 20 in the form of a mesh or a hole-punched sheet of the metal such as Mo, Nb, or W on a surface of the base plate 11. Still alternatively, the electrode 20 may also be formed by depositing a thin film on a surface of the base plate 11 with CVD or PVD.

Next, the dielectric material layer 12 is formed. A binder and, as needed, water, a dispersing agent, and the like are added to and mixed with ceramic raw material powder having a volume resistivity of not less than 1×10¹⁵ Ω·cm at 100° C., 150° C., and 200° C. similarly to the main constituent of the base plate 11, thus preparing slurry. The ceramic raw material powder can contain ceramic powder as a main constituent, and sintering aids. The ceramic raw material powder essentially contains aluminum nitride powder, and sintering aids such as magnesia, yttria, and titanium oxide are added thereto. It should be noted, however, that it is preferred that the total amount of constituents except for the raw material of the main constituent is not more than 12 wt %. Further, in the case where aluminum nitride is contained essentially in the raw material powder, it is preferred that the average grain size is approximately 1 μm. This makes it possible to lower sintering temperature. The slurry obtained is granulated by spray granulation or the like, thus obtaining granules. The base plate 11 having the electrode 20 formed thereon is set in a die or the like, and the granules obtained are stuffed into a space on the base plate 11 and the electrode 20, thus forming on the base plate 11 a molded body which becomes the dielectric material layer 12. Alternatively, a molded body which is the dielectric material layer 12 may be formed by die pressing, cold isostatic pressing (CIP), slip casting, or the like using the granules, and then placing the molded body on the base plate 11 having the electrode 20, and pressing the both of the molded body and the base plate.

Then, the base plate 11, the electrode 20, and the molded body which is the dielectric material layer 12 are sintered into a single body by hot pressing under conditions (sintering atmosphere, sintering method, sintering temperature, sintering time, and the like) according to the ceramic raw material powder of the molded body, thus obtaining a single-piece sintered body. Thus, the dielectric material layer 12 can be formed. In the case where aluminum nitride is essentially contained in the raw material powder, it is preferred that the molded body is sintered at 1550 to 2000° C. in an inert gas atmosphere such as nitrogen gas or argon gas while being uniaxially pressurized. In the case where the sintering temperature is less than 1550° C., densification is difficult. In the case where the sintering temperature exceeds 2000° C., the volume resistance of the sintered body is lowered. More preferable temperature is 1600 to 2000° C. This makes it possible to further stabilize the volume resistivity of the dielectric material layer 12 obtained. Further, it is preferred that to maximum temperature, the temperature is raised at a heating rate of not more than 200° C./hour. It is preferred that the temperature is held at the maximum temperature for one to ten hours. Furthermore, it is preferred that the pressure applied is 10 to 30 MPa. This makes it possible to obtain a denser sintered body as the dielectric material layer 12.

It should be noted that the sequence of the process steps may be arbitrarily changed. For example, the sequence may be as follows: the dielectric material layer 12 is formed first; the electrode 20 is formed on the dielectric material layer 12; a molded body which becomes the base plate 11 is formed on the dielectric material layer 12 and the electrode 20; and then the dielectric material layer 12, the electrode 20, and the base plate 11 are sintered into a single body.

The flatness of the electrode 20 can be improved by obtaining any one of the base plate 11 and the dielectric material layer 12 by sintering, then forming the electrode 20, and forming the rest into a single body. This makes it possible to improve the uniformity of the electrostatic clamping force of the electrostatic chuck and the temperature uniformity of the electrostatic chuck.

Alternatively, a stacked structure including a molded body which becomes the base plate 11, the electrode 20, and a molded body which becomes the dielectric material layer 12 may be formed, and the stacked structure obtained may be sintered into a single body by hot pressing.

The electrode 20 may be embedded in the dielectric material layer 12 instead of disposing between the base plate 11 and the dielectric material layer 12.

Next, the single-piece sintered body obtained is processed. Specifically, it is preferred that the dielectric material layer 12 is ground so that the thickness of the dielectric material layer 12 is 0.5 mm or less. Further, it is preferred that the dielectric material layer 12 is ground so that the center line average surface roughness (Ra) of the substrate contact surface 12d of the dielectric material layer 12 is 1.6 μm or less. Moreover, the hole 11a for inserting the terminal 21 is formed in the base plate 11 by boring. Finally, the terminal 21 is inserted into the hole 11a of the base plate 11, and the terminal 21 is brazed to the electrode 20, thus obtaining the electrostatic chuck 100.

As described above, an electrostatic chuck which uses Coulomb force in a high-temperature environment and has high volume resistance and high thermal conductivity can be obtained by the steps of forming the base plate 11 of ceramic having a higher thermal conductivity than the dielectric material layer 12, forming the electrode 20 for generating an electrostatic clamping force, and forming on the electrode 20 the dielectric material layer 12 of ceramic having a volume resistivity of not less than 1×10¹⁵ Ω·cm at 100° C., 150° C., and 200° C. and the same main constituent as the base plate 11.

Various modifications will become possible for those skilled in the art after receiving the teachings of the present disclosure without departing from the scope thereof.

### EXAMPLES

Next, the present invention will be described in more detail using examples. However, the present invention is not limited to the following examples at all.

(Electrostatic Chuck)

### Examples 1 to 4, Comparative Examples 1 and 2

First, a base plate was formed. Specifically, as ceramic raw material powder, prepared was a powdery mixture containing 92.5 to 100.0 wt % aluminum nitride powder obtained by reduction-nitridation, 0 to 2.0 wt % magnesia powder, 0 to 5.0 wt % yttria powder, and 0 to 0.5 wt % titanium oxide powder. An acrylic resin binder was added to the ceramic raw material powder and mixed therewith using a ball mill, thus obtaining slurry.

Granules were prepared by spray granulation. Specifically, the obtained slurry was sprayed and dried by a spray dryer, thus preparing granules. The granules obtained were uniaxially pressurized and molded by die molding to be formed into a plate-shaped molded body.

The molded body was sintered in a nitrogen gas atmosphere by hot pressing, thus obtaining a sintered aluminum nitride material. Specifically, while pressurization at 20 MPa was being performed, the temperature was raised to maximum temperature at a heating rate of 10 to 150° C./hour and held at the maximum temperature for two hours. It should be noted that the maximum temperatures of examples were 1830° C. and those of comparative examples were 1700° C. The sintered aluminum nitride material was grinding-machined, thus preparing a disk having a diameter of 215 mm and a thickness of 10 mm.

Next, cellulose, acrylic, polyvinyl butyral, or the like was mixed as a binder with tungsten carbide (WC) powder, thus preparing print paste. An electrode having a thickness of 20 μm was formed on the sintered aluminum nitride material by screen printing and dried.

Then, the sintered aluminum nitride material having the electrode formed thereon was set in a die. The aluminum nitride granules were stuffed into a space on the sintered aluminum nitride material and the electrode, and are pressurized, thus performing press molding.

The sintered aluminum nitride material, the electrode, and the aluminum nitride molded body molded into a single body, were set in a sheath made of carbon and were sintered in a nitrogen gas atmosphere by hot pressing. Specifically, while pressurization at 20 MPa was performed, the temperature was raised to a maximum temperature of 1700° C. at a heating rate of 10° C./hour and held at this maximum temperature of 1700° C. for two hours, thus sintering the sintered aluminum nitride material, the electrode, and the aluminum nitride molded body into a single body.

The surface of the dielectric material layer undergoes surface grinding using a diamond wheel, and the thickness of the dielectric material layer was reduced to 0.5 mm or less. Thus, the dielectric material layer was formed.

Moreover, grinding was performed so that the center line average surface roughness (Ra) of the substrate contact surface is 0.8 μm or less. Further, the side surface of the sintered aluminum nitride material was ground, needed hole making was performed, and a terminal which connects to the electrode was bonded thereto, whereby an electrostatic chuck was completed.

The following evaluations (1) to (4) were made for electrostatic chucks obtained:

(1) Volume Resistance Measurement

Volume resistance measurement of the dielectric layer was performed by a method according to JIS C2141. Specifically, measurement was performed from room temperature to 150° C. in a vacuum atmosphere. Test geometry was as follows: a main electrode and a guard electrode made of silver paste are formed on the surface of the electrostatic chuck having a diameter of 200 mm and a thickness of 10 mm; the main electrode has a diameter of 20 mm; and the guard electrode has an inner diameter of 30 mm and an outer diameter of 40 mm. To the electrode of the electrostatic chuck, 2 kV/mm was applied. The current one minute after the application of voltage was read. Then, the volume resistivity was calculated.

(2) Thermal Conductivity Measurement

Thermal conductivity measurement was performed by a laser flash method according to JIS R1611.

(3) Temperature Measurement

The difference in temperature between the upper and lower surfaces of the electrostatic chuck was measured. Specifically, a heat input of 3 kW was applied to the surface of the manufactured electrostatic chuck having a diameter of 200 mm and a thickness of 10 mm using a lamp heater. A cooling plate was brought into contact with the back surface of the electrostatic chuck, and the temperature of the back was fixed at 20° C. The temperature of the surface of the electrostatic chuck at this time was measured, and the difference in temperature between the upper and lower surfaces of the electrostatic chuck was calculated.

(4) Clamping Force Measurement

In a vacuum, a silicon probe was brought into contact with the substrate contact surface of the electrostatic chuck. Voltage application of 2 kV/mm was performed between the electrode of the electrostatic chuck and the silicon probe. The silicon probe was adsorbed and fixed to the electrostatic chuck. After 60 seconds form the application of the voltage, the silicon probe was pulled up towards a direction in which the silicon probe is peeled off from the substrate contact surface, while applying the voltage. A force needed to peel the silicon probe off, was measured as a clamping force.

It should be noted that the area of the tip of the silicon probe was 3 cm² and that measurement was performed at room temperature and 150° C.

Results of the evaluations of (1) to (4) are shown in Table 1 and Table 2.

TABLE 1

| | The dielectric material layer | | | | The base plate | | | |
|---|---|---|---|---|---|---|---|---|
| | Amount of additive | | | | Amount of additive | | | |
| | in raw material | | | | in raw material | | | |
| | powder | | | Sintering | powder | | | Sintering |
| | MgO | Y₂O₃ | TiO₂ | temperature | MgO | Y₂O₃ | TiO₂ | temperature |
| Item | wt % | wt % | wt % | ° C. | wt % | wt % | wt % | ° C. |
| Examples 1 | 2 | 5 | — | 1700 | — | — | — | 1830 |
| Examples 2 | 2 | 5 | — | 1700 | — | 5 | — | 1830 |
| Examples 3 | 2 | 5 | 0.5 | 1700 | — | — | — | 1830 |
| Examples 4 | 2 | 5 | 0.5 | 1700 | — | 5 | — | 1830 |
| Comparative | 2 | 5 | — | 1700 | 2 | 5 | — | 1700 |
| examples 1 | | | | | | | | |
| Comparative | 2 | 5 | 0.5 | 1700 | 2 | 5 | 0.5 | 1700 |
| examples 2 | | | | | | | | |

TABLE 2

| | Measurement result of characteristic | | | | | | |
|---|---|---|---|---|---|---|---|
| | The volume resistivity of the | | | | | Electrostatic | |
| | dielectric material layer | | | | | clamping force | |
| | Room | | | | Temperature | Room | |
| | temperature | 100° C. | 150° C. | Thermal | difference | temperature | 150° C. |
| | 2 kV/mm | 2 kV/mm | 2 kV/mm | conductivity | ΔT | 2 kV/mm | 2 kV/mm |
| Item | Ω · cm | Ω · cm | Ω · cm | W/mK | ° C. | kPa | kPa |
| Examples 1 | >1.0 × 10¹⁵ | >1.0 × 10¹⁵ | >1.0 × 10¹⁵ | 90 | 10.6 | >2.7 | >2.7 |
| Examples 2 | >1.0 × 10¹⁵ | >1.0 × 10¹⁵ | >1.0 × 10¹⁵ | 170 | 5.5 | >2.7 | >2.7 |
| Examples 3 | >1.0 × 10¹⁵ | >1.0 × 10¹⁵ | >1.0 × 10¹⁵ | 89 | 10.4 | >2.7 | >2.7 |
| Examples 4 | >1.0 × 10¹⁵ | >1.0 × 10¹⁵ | >1.0 × 10¹⁵ | 170 | 5.6 | >2.7 | >2.7 |
| Comparative | >1.0 × 10¹⁵ | >1.0 × 10¹⁵ | >1.0 × 10¹⁵ | 48 | 20.0 | >2.7 | >2.7 |
| examples 1 | | | | | | | |
| Comparative | >1.0 × 10¹⁵ | >1.0 × 10¹⁵ | >1.0 × 10¹⁵ | 41 | 23.9 | >2.7 | >2.7 |
| examples 2 | | | | | | | |

Each of examples 1 to 4 describes an electrostatic chuck including a base plate which contains aluminum nitride as a main constituent and 0 to 5 wt % yttria and which has been sintered at 1830° C.; a dielectric material layer which contains aluminum nitride as a main constituent, 2 wt % magnesia, 5 wt % yttria, and 0 to 0.5 wt % titanium oxide and which has been sintered at 1700° C.; and an electrode. The amounts of constituents of examples 1 to 4 are shown in Table 1.

Each of comparative examples 1 and 2 describes an electrostatic chuck including a base plate which contains aluminum nitride as a main constituent, 2 wt % magnesia, 5 wt % yttria, and 0 to 0.5 wt % titanium oxide and which has been sintered at 1700° C.; a dielectric material layer which contains aluminum nitride as a main constituent, 2 wt % magnesia, 5 wt % yttria, and 0 to 0.5 wt % titanium oxide and which has been sintered at 1700° C.; and an electrode. The amounts of constituents of comparative examples 1 and 2 are shown in Table 1.

In each of examples 1 to 4, the base plate was sintered at 1830° C., and a base plate having a very high thermal conductivity was obtained.

Further, in each of the electrostatic chucks of examples 1 to 4, the thermal conductivity is 89 to 170 W/mK, and the difference in the temperature measurement is 5.5 to 10.6° C. Each of the electrostatic chucks of examples 1 to 4 has an improved thermal conductivity and an improved temperature difference in the temperature measurement which is associated with the foregoing while maintaining the volume resistivity at room temperature, 100° C., and 150° C., compared with the electrostatic chucks of comparative examples 1 to 4 in which the thermal conductivity is 41 to 48 W/mK and in which the temperature difference in the temperature measurement is 20 to 23.9° C.

In particular, example 2 describes an electrostatic chuck including a base plate that contains aluminum nitride and 5 wt % yttria and has been sintered at 1830° C.; a dielectric material layer that contains aluminum nitride, 2 wt % magnesia, and 5 wt % yttria and has been sintered at 1700° C.; and an electrode, whose thermal conductivity and temperature difference in the temperature measurement are dramatically improved to 170 W/mK and 5.5° C., respectively, compared to those of comparative examples 1 and 2.

Moreover, example 4 describes an electrostatic chuck including a base plate that contains aluminum nitride and 5 wt % yttria and has been sintered at 1830° C.; a dielectric material layer that contains aluminum nitride, 2 wt % magnesia, 5 wt % yttria, and 0.5 wt % titanium oxide and has been sintered at 1700° C.; and an electrode, whose thermal conductivity and the temperature difference in the temperature measurement are dramatically improved to 170 W/mK and 5.6° C., respectively, compared to those of comparative examples 1 and 2.

On the other hand, comparative example 1 describes an electrostatic chuck including a base plate that contains 2 wt % magnesia and 5 wt % yttria and has been sintered at 1700° C.; a dielectric material layer that contains aluminum nitride, 2 wt % magnesia, and 5 wt % yttria and has been sintered at 1700° C.; and an electrode, whose thermal conductivity is very poor. In addition, the temperature difference in the temperature measurement is also very poor.

Comparative example 2 describes an electrostatic chuck including a base plate that contains 2 wt % magnesia, 5 wt % yttria, and 0.5 wt % titanium oxide and has been sintered at 1700° C.; a dielectric material layer that contains aluminum nitride, 2 wt % magnesia, 5 wt % yttria, and 0.5 wt % titanium oxide and has been sintered at 1700° C.; and an electrode, whose thermal conductivity is very poor. In addition, the temperature difference in the temperature measurement is also very poor.

What is claimed is:

1. An electrostatic chuck, comprising:
a base plate made of ceramic;
an electrode for generating an electrostatic clamping force; and
a dielectric material layer formed on the electrode, and made of ceramic having a volume resistivity of not less than 1×10¹⁵ Ω·cm at 100° C. and the same main constituent as the base plate,
wherein the base plate has a higher thermal conductivity than the dielectric material layer.

2. The electrostatic chuck of claim 1, wherein the base plate has a thermal conductivity of not less than 80 W/mK.

3. The electrostatic chuck of claim 1, wherein the dielectric material layer has a volume resistivity of not less than 1×10¹⁵ Ω·cm at 150° C.

4. The electrostatic chuck of claim 1, wherein the dielectric material layer has a volume resistivity of not less than 1×10¹⁵ Ω·cm at 200° C.

5. The electrostatic chuck of claim 1, wherein the ceramic essentially contains aluminum nitride.

6. The electrostatic chuck of claim 1, wherein the dielectric material layer contains 0.4 to 2.5 wt % magnesium and 2.0 to 5.0 wt % yttrium, and has an average grain size of not more than 1.0 μm.

7. A method of manufacturing an electrostatic chuck, comprising:
forming a base plate made of ceramic;
forming an electrode for generating an electrostatic clamping force; and
forming on the electrode a dielectric material layer made of ceramic having a volume resistivity of not less than 1×10¹⁵ Ω·cm at 100° C. and the same main constituent to the foregoing ceramic,
wherein the base plate has a higher thermal conductivity than the dielectric material layer.

8. The method of claim 7, wherein the base plate has a thermal conductivity of not less than 80 W/mK.

9. The method of claim 7, wherein the dielectric material layer has a volume resistivity of not less than 1×10¹⁵ Ω·cm at 150° C.

10. The method of claim 7, wherein the dielectric material layer has a volume resistivity of not less than 1×10¹⁵ Ω·cm at 200° C.

11. The method of claim 7, further comprising,
sintering any one of the base plate and a first molded body which becomes the base plate, any one of the dielectric material layer and a second molded body which becomes the dielectric material layer, and the electrode into a single body by hot pressing.
